(19) United States
(12) Patent Application Publication
(10) Pub. No.: US 2013/0274379 A1
(43) Pub. Date: Oct. 17, 2013

(54) POLYMER CONCRETE COMPOSITION

(71) Applicant: Rajesh Turakhia, Lake Jackson, TX (US)

(72) Inventor: Rajesh Turakhia, Lake Jackson, TX (US)

(21) Appl. No.: 13/701,694

(22) PCT Filed: Jun. 21, 2011
(86) PCT No.: PCT/US11/41138

§ 371 Date: Dec. 3, 2012

Related U.S. Application Data
(60) Provisional application No. 61/358,478, filed on Jun. 25, 2010.

(51) Int. Cl. C04B 16/04

(52) U.S. Cl. CPC C04B 16/04
USPC 523/401

(57) ABSTRACT

A curable composition for polymer concrete including (A) at least one epoxy resin composition comprising (A1) at least one epoxy resin, and (A2) at least one divinylarene dioxide; and (B) at least one hardener composition; wherein the divinylarene dioxide is present in the epoxy resin composition in a sufficient concentration such that the divinylarene dioxide reduces the viscosity of the curable composition and provides the necessary properties for cured polymer concrete product made from the curable composition. The divinylarene dioxide reduces the viscosity of the curable composition and, at the same time, provides the necessary properties for polymer concrete applications; and the divinylarene dioxide helps to increase heat deflection temperature (HDT) of the polymer concrete and improves the dimensional stability of a large polymer concrete part without sacrificing any of the other properties of the polymer concrete.

### BACKGROUND OF THE INVENTION

1. Field of the Invention

The present invention is related to a curable polymer concrete composition having a divinylarene dioxide and a cured product made from said curable polymer concrete composition.

2. Description of Background and Related Art

Curable compositions useful for the manufacture of polymer concrete, which in turn is used for manufacturing cured products such as machine tools typically use an epoxy, for example a mono or diglycidyl ether, as a diluent for the polymer concrete compositions. Typically, the epoxy diluent is mixed with a commercially available liquid epoxy resin, such as D.E.R.™ 331, and together with a curing agent form a curable polymer concrete composition. The presence of the epoxy diluent helps to reduce the viscosity of the curable composition to a viscosity level necessary for the curable composition to be useful in polymer concrete applications.

However, an epoxy diluent used in a curable formulation, such as a formulation used for manufacturing large polymer concrete parts, also reduces the reactivity and the glass transition temperature of the formulation; and at the same time, disadvantageously provides the resultant cured product, made from the curable formulation containing the epoxy diluent, with reduced properties necessary for the polymer concrete part.

For example, one important property measured in polymer concrete is heat deflection temperature (HDT) which can be reduced in the cured product when made from a formulation containing an epoxy diluent. HDT in polymer concrete applications is an indicator of dimensional stability of a large (e.g., generally from 50 kg to 10,000 kg) polymer concrete part; wherein “dimensional stability” is the ability of a concrete part to retain its shape when subjected to higher temperatures.

Therefore, it would be advantageous in the construction industry if the HDT of polymer concrete part could be increased without detrimentally affecting the other properties of the polymer concrete such as the viscosity, reactivity, glass transition temperature, and mechanical properties of the thermoset (curable polymer) system.

It is desired to improve the HDT of a large polymer concrete part, which in turn, improves the dimensional stability of the large polymer concrete part, while maintaining a good balance of other properties of the polymer concrete part. It is also desired to replace the epoxy diluent used in curable compositions previously used in the prior art with an alternate compound that does not have the problems of the epoxy diluent of the prior art.

### SUMMARY OF THE INVENTION

In one embodiment, the present invention is directed to a polymer concrete formulation including a divinylarene dioxide such as divinylbenzene dioxide (DVBDO). The divinylarene dioxide (e.g. DVBDO) reduces the viscosity of the curable composition and, at the same time, provides the composition with properties necessary for manufacturing polymer concrete; without the disadvantages of the known epoxy diluents used in polymer concrete formulations.

For example, one of advantages of using a divinylarene dioxide in the present invention polymer concrete compositions is that the divinylarene dioxide helps to increase HDT of a cured product made from the curable composition without sacrificing any of the other properties of the curable composition or the cured product made therefrom. The improvement in HDT provides improved dimensional stability of a large polymer concrete part. The use of the divinylarene dioxide also helps to keep the viscosity of the composition similar to the viscosity of, for example, a composition using an epoxy diluent of the prior art.

### DETAILED DESCRIPTION OF THE INVENTION

One broad embodiment of the present invention comprises a curable composition for polymer concrete comprising (A) at least one epoxy resin composition comprising (A1) at least one epoxy resin, and (A2) at least one divinylarene dioxide; (B) a hardener composition; and (C) at least one aggregates; wherein the divinylarene dioxide is present in the epoxy resin composition in a sufficient concentration such that the divinylarene dioxide reduces the viscosity of the curable composition; and provides improvement in HDT without sacrificing glass transition temperature (Tg) and mechanical properties for cured polymer concrete product made from the curable composition.

In preparing the curable polymer concrete resin composition mixture of the present invention, the mixture may include at least one epoxy resin, component (A1). Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. The epoxy resin useful in the present invention may be selected from any known epoxy resins in the art. An extensive enumeration of epoxy resins useful in the present invention is found in Lee, H. and Neville, K., Handbook of Epoxy Resins, McGraw-Hill Book Company, New York, 1967, Chapter 2, pages 257-307; incorporated herein by reference.

The epoxy resins, used in embodiments disclosed herein for component (A1) of the present invention, may vary and include conventional and commercially available epoxy resins, which may be used alone or in combinations of two or more. In choosing epoxy resins for compositions disclosed herein, consideration should not only be given to properties of the final product, but also to viscosity of the composition and its other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resin useful in the present invention for the preparation of the curable epoxy resin composition may be selected from commercially available products. For example, D.E.R.™ 331™, D.E.R. 332, D.E.R. 334, D.E.R. 580, D.E.N.™ 431, D.E.N. 438, D.E.R. 736, or D.E.R. 732 epoxy resins available from The Dow Chemical Company may be used. As an illustration of the present invention, the epoxy resin component (a) may be a liquid epoxy resin, D.E.R. 383 (DGEBPA) having an epoxide equivalent weight of 175-185, a viscosity of 9.5 Pa-s and a density of 1.16 g/cc. Other commercial epoxy resins that can be used for the epoxy resin component can be D.E.R. 330, D.E.R. 354, or D.E.R. 332.

Other suitable epoxy resins useful in the present invention are disclosed, for example, in U.S. Pat. Nos. 3,018,262; 7,163,973; 6,887,574; 6,632,893; 6,242,083; 7,037,958; 6,572,971; 6,153,719; and 5,405,688; PCT Publication WO 2006/052727; and U.S. Patent Application Publication Nos. 20060293172, 20050171237, and 2007/0221890 A1; each of which is hereby incorporated herein by reference.

In a preferred embodiment, the epoxy resin useful in the composition of the present invention comprises any aromatic or aliphatic glycidyl ether or glycidyl amine or a cycloaliphatic epoxy resin. For example, one embodiment of the epoxy resin used in the present invention may be diglycidyl ether of bisphenol A (DGEBA) and derivatives thereof. Other epoxy resins can be selected from but limited to the groups of: bisphenol F epoxy resins, novolac epoxy resins, glycidylamine-based epoxy resins, alicyclic epoxy resins, linear aliphatic epoxy resins, tetrabromobisphenol A epoxy resins, and combinations thereof.

The at least one epoxy resin, component (A1), may be present in the epoxy resin mixture composition at a concentration ranging generally from about 40 weight percent (wt %) to about 95 wt %, preferably from about 50 wt % to about 90 wt %, and more preferably from about 65 wt % to about 85 wt %. Using above and below the concentration as mentioned above will impact viscosity and reactivity and hence physical and mechanical properties.

In a broad embodiment of the present invention, the epoxy resin formulation, component (A) of curable polymer concrete composition, includes at least one divinylarene dioxide compound, component (A2). The divinylarene dioxide compound useful in the present invention may comprise, for example, any substituted or unsubstituted arene nucleus bearing one, two, or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

The divinylarene dioxide compound used for preparing the composition of the present invention may be illustrated generally by general chemical Structures I-IV as follows:

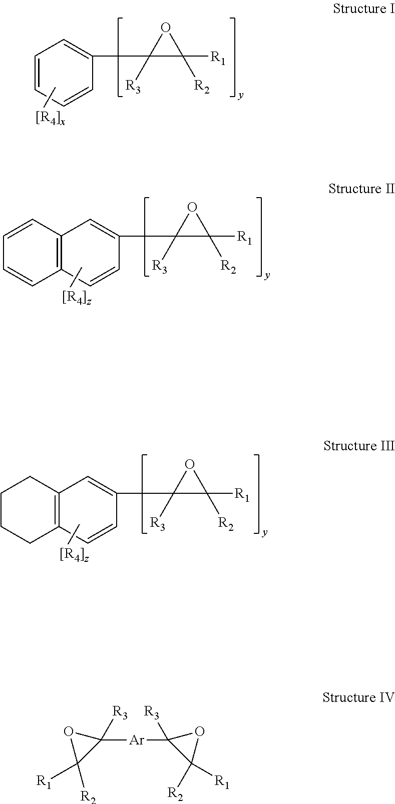

In the above Structures I, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide used in the present invention may be produced, for example, by the process described in U.S. Patent Provisional Application Ser. No. 61/141,457, filed Dec. 30, 2008, by Marks et al., incorporated herein by reference. The divinylarene dioxide compositions that are useful in the present invention are also disclosed in, for example, U.S. Pat. No. 2,924,580, incorporated herein by reference.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide compound used in the epoxy resin formulation may be for example divinylbenzene dioxide (DVBDO). Most preferably, the divinylarene dioxide compound that is useful in the present invention includes, for example, a divinylbenzene dioxide as illustrated by the following chemical formula of Structure V:

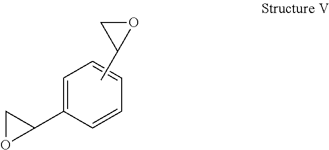

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and O, 19.73 with an epoxide equivalent weight of about 81 g/mol.

Divinylarene dioxides, particularly those derived from divinylbenzene such as for example DVBDO, are class of diepoxides which have a relatively low liquid viscosity but a higher rigidity and crosslink density than conventional epoxy resins.

Structure VI below illustrates an embodiment of a preferred chemical structure of the DVBDO useful in the present invention:

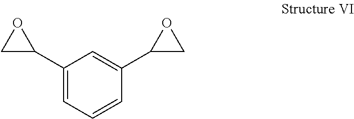 [SMILES: c1cc(C2CO2)cc(C2CO2)c1]

Structure VII below illustrates another embodiment of a preferred chemical structure of the DVBDO useful in the present invention:

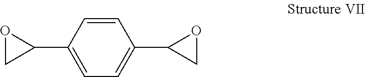 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) and para isomers of DVBDO, respectively. The ortho isomer is rare; and usually DVBDO is mostly produced generally in a range of from about 9:1 to about 1:9 ratio of meta (Structure VI) to para (Structure VII) isomers. The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In yet another embodiment of the present invention, the divinylarene dioxide may contain quantities (such as for example less than about 20 wt %) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight (as measured by ASTM D-1652) of the divinylarene dioxide to a value greater than that of the pure compound but can be utilized at levels of 0 to 99% of the epoxy resin portion.

In one embodiment, the divinylarene dioxide useful in the present invention comprises, for example, DVBDO, a low viscosity liquid epoxy resin. The viscosity of the divinylarene dioxide used in the process of the present invention ranges generally from about 0.001 Pa s to about 0.1 Pa s, preferably from about 0.01 Pa s to about 0.05 Pa s, and more preferably from about 0.01 Pa s to about 0.025 Pa s, at 25° C.

The utility of the divinylarene dioxides of the present invention requires thermal stability to allow formulating or processing the divinylarene dioxides at moderate temperatures (for example, at temperatures of from about 100° C. to about 200° C.) for up to several hours (for example, for at least 2 hours) without oligomerization or homo-polymerization. Oligomerization or homopolymerization during formulation or processing is evident by a substantial increase (e.g., greater than 50 fold) in viscosity or gelling (crosslinking). The divinylarene dioxides of the present invention have sufficient thermal stability such that the divinylarene dioxides do not experience a substantial increase in viscosity or gelling during formulation or processing at the aforementioned moderate temperatures.

Another advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from about 6 to about 10, preferably from about 6 to about 9, and more preferably from about 6 to about 8 rotational degrees of freedom.

The concentration of the divinylbenzene dioxide in the polymer concrete formulation of the present invention will depend on what other formulation ingredients are used in the formulation and will depend on the concentrations of the other formulation ingredients. In general, the concentration of the divinylarene oxide used in the present invention as component (A2) of the formulation may range generally from about 5 wt % to about 60 wt % in one embodiment; from about 10 wt % to about 50 wt % in another embodiment; from about 12 wt % to about 40 wt % in still another embodiment; and from about 15 wt % to about 35 wt % in yet another embodiment, based on the weight of the total composition. Using above and below the concentration as mentioned above will impact viscosity and reactivity and hence physical and mechanical properties.

The hardener composition, component (B), useful for the curable polymer concrete resin composition of the present invention, may comprise any conventional hardener known in the art for curing epoxy resins. The hardener (also referred to as a curing agent or cross-linking agent) useful in the curable polymer concrete composition, may be selected, for example, from those curing agents well known in the art including, but are not limited to, anhydrides, carboxylic acids, amine compounds, phenolic compounds, polyols, or mixtures thereof.

Examples of hardener compositions useful in the present invention may include any of the co-reactive or catalytic curing materials known to be useful for curing epoxy resin based compositions. Such co-reactive curing agents include, for example, polyamine, polyetheramine, polyamide, polyaminoamide, dicyandiamide, polyphenol, polymeric thiol, polycarboxylic acid and anhydride, and any combination thereof or the like. Suitable catalytic curing agents include tertiary amine, quaternary ammonium halide, Lewis acids such as boron trifluoride, and any combination thereof or the like. Other specific examples of co-reactive curing agent include phenol novolacs, bisphenol-A novolacs, phenol novolac of dicyclopentadiene, cresol novolac, diaminodiphenylsulfone, styrene-maleic acid anhydride (SMA) copolymers; and any combination thereof. Among the conventional co-reactive epoxy curing agents, amines and amino or amido containing resins and phenolics are preferred.

Dicyandiamide (“dicy”) may be one preferred embodiment of the curing agent useful in the present invention. Dicy has the advantage of providing delayed curing since dicy requires relatively high temperatures for activating its curing properties; and thus, dicy can be added to an epoxy resin and stored at room temperature (about 25° C.).

The amount of the hardener used in the curable polymer concrete resin composition generally ranges from about 5 wt % to about 60 wt %, preferably from about 10 wt % to about 50 wt %, and more preferably from about 20 wt % to about 40 wt %. Generally, the amount of curing agent used is at stoichiometric balance or less based on equivalents compared to that of the epoxide groups. Using above and below the concentration as mentioned above will impact viscosity and reactivity and hence physical and mechanical properties.

The present invention includes one or more aggregates which are useful in preparing the curable polymer concrete resin composition. An “aggregates” is a material used in construction industry and may include for example, silica, sand, gravel, ceramic, crushed stones, quartz, granite, and mixtures thereof may be used as the aggregates in the present invention. The particulates of the aggregates useful in the present invention is of a sufficient size such as the diameter of the particulate is for example generally from about 0.01 mm to about 30 mm in one embodiment; and from about 0.04 mm to about 15 mm in another embodiment. Aggregates useful in the present invention are described, for example, in American Concrete Institute, ACI Education Bulletin E1-07, “Aggregates for Concrete”, August 2007.

The concentration of the aggregates used in the present invention may range generally from 50 wt % to about 95 wt %, preferably from about 60 wt % to about 95 wt %, more preferably from about 70 wt % to about 95 wt %, and most preferably from about 85 wt % to about 95 wt %. Lower level of aggregates than those mentioned above will result in poor mechanical properties.

In preparing the curable compositions of the present invention, in one embodiment, for example, the curable polymer concrete resin composition of the present invention may optionally include at least one curing catalyst. The catalyst used in the present invention may be adapted for polymerization, including homopolymerization, of the at least one epoxy resin. Alternatively, the catalyst used in the present invention may be adapted for a reaction between the at least one epoxy resin and the at least one curing agent, if the catalyst is used.

The optional curing catalyst useful in the present invention may include catalysts well known in the art, such as for example, catalyst compounds containing amine, phosphine, heterocyclic nitrogen, ammonium, phosphonium, arsonium, sulfonium moieties, and any combination thereof. Some non-limiting examples of the catalyst of the present invention may include, for example, ethyltriphenylphosphonium; benzyltrimethyl-lammonium chloride; heterocyclic nitrogen-containing catalysts described in U.S. Pat. No. 4,925,901, incorporated herein by reference; imidazoles; triethylamine; and any combination thereof.

The selection of the curing catalyst useful in the present invention is not limited and commonly used catalysts for epoxy systems can be used. When the catalyst is used, preferred examples of catalyst include tertiary amines, imidazoles, organo-phosphines, acid salts, and mixtures thereof.

Most preferred curing catalysts include tertiary amines and imidazoles such as, for example, triethylamine, tripropylamine, tributylamine, 2-methylimidazole, benzyldimethylamine, 2-phenylimidazole, and mixtures thereof and the like.

The concentration of the optional catalyst used in the present invention may range generally from 0 wt % to about 5 wt %, preferably from about 0.01 wt % to about 7 wt %, more preferably from about 1 wt % to about 8 wt %, and most preferably from about 2 wt % to about 10 wt %.

The curable composition of the present invention may optionally contain one or more other additional additives which are useful for their intended uses such as additives known to be useful for the preparation, storage, and curing of polymer concrete resin compositions. For example, the optional additives useful in the present invention composition may include, but not limited to, reaction catalysts, resin stabilizers, processing aids, solvents, other resins, fillers, fibers, plasticizers, catalyst de-activators, surfactants, flow modifiers, colorants, pigments, dyes, matting agents, degassing agents, flame retardants (e.g., inorganic flame retardants, halogenated flame retardants, and non-halogenated flame retardants such as phosphorus-containing materials), toughening agents, curing initiators, curing inhibitors, wetting agents, de-foamers, thermoplastics, processing aids, UV blocking compounds, fluorescent compounds, UV stabilizers, fibrous reinforcements, antioxidants, impact modifiers including thermoplastic particles, and mixtures thereof. The above list is intended to be exemplary and not limiting. The preferred additives for the formulation of the present invention may be optimized by the skilled artisan.

The concentration of the optional additives used in the present invention may range generally from 0 wt % to about 5 wt %, preferably from about 0.01 wt % to about 7 wt %, more preferably from about 1 wt % to about 8 wt %, and most preferably from about 2 wt % to about 10 wt %.

The preparation of the curable polymer concrete resin composition of the present invention is achieved by admixing in a vessel the following components: the epoxy resin formulation as a Part A; and a hardener composition as a Part B, with optionally a catalyst, and other additives added to Part A or Part B; and then allowing the components to formulate into a polymer concrete resin thermoset composition. The components of the formulation or composition of the present invention may be admixed in any order to provide the thermosettable composition of the present invention. Any of the above-mentioned optional assorted formulation additives, for example fillers, may also be added to the composition during the mixing or prior to the mixing to form the composition.

All the components of the polymer concrete resin composition are typically mixed and dispersed at a temperature enabling the preparation of an effective epoxy resin composition having a low viscosity for the desired polymer concrete application. The temperature during the mixing of all components may be generally from about 0° C. to about 100° C. and preferably from about 20° C. to about 50° C.

The polymer concrete resin composition of the present invention, prepared from the divinylarene dioxides described above, has improved HDT without sacrificing the mechanical properties of the finished cured product. For example, the HDT of the polymer concrete resin based thermoset of the present invention ranges generally from about 50° C. to about 300° C.; preferably, from about 45° C. to about 275° C.; and more preferably, from about 40° C. to about 150° C.

The viscosity of the polymer concrete resin composition prepared by the process of the present invention ranges generally from about 100 mPa-s to about 200,000 mPa-s; preferably, from about 150 mPa-s to about 100,000 mPa-s; and more preferably, from about 200 mPa-s to about 50,000 mPa-s, at 25° C.

The curable polymer concrete resin formulation or composition of the present invention can be cured under conventional processing conditions to form a thermoset. The resulting thermoset or cured product displays excellent thermo-mechanical properties, such as good toughness and mechanical strength, while maintaining high thermal stability.

The process to produce the thermoset products of the present invention may be performed by gravity casting, vacuum casting, dipping, spraying; with consolidating with vibration; and the like as formulated by those skilled in the art.

The curing reaction conditions include, for example, carrying out the reaction under a temperature, generally in the range of from about 0° C. to about 300° C.; preferably, from about 5° C. to about 250° C.; and more preferably, from about 10° C. to about 120° C.

The curing of the curable or thermosettable composition may be carried out, for example, for a predetermined period of time sufficient to cure the composition. For example, the curing time may be chosen between about 1 minute to about 24 hours, preferably between about 10 minutes to about 12 hours, and more preferably between about 100 minutes to about 8 hours.

The curing process of the present invention may be a batch or a continuous process. The reactor used in the process may be any reactor and ancillary equipment well known to those skilled in the art.

The cured product prepared by curing the polymer concrete resin composition of the present invention advantageously exhibits an improved HDT with a balance of thermal and mechanical properties. While, HDT typically depends on the curing agent, aggregates and the epoxy resin used, as one illustration, the HDT of the polymer concrete resins of the present invention may be from about 50 percent (%) to about 100% higher than its corresponding conventional polymer concrete resin. Generally, the HDT of the polymer concrete resins of the present invention may be from about 40° C. to about 200° C.; and more preferably from about 50° C. to about 130° C.

As one illustration of the present invention, a cured polymer concrete composite product can be made with the curable polymer concrete resin composition of the present invention and with a reinforcing material incorporated into the resin composition. For example, the reinforcing material may be selected from metal inserts, glass, carbon, or polymer fibers including for example, continuous filaments, woven and non-woven mats, and chopped filaments; and mixtures thereof.

As an illustration of the present invention, in general, the cured polymer concrete products of the present invention may be useful for precision machine tools and the like. One of the advantages of a machine tool made of the present cured polymer concrete is increased vibration damping versus a comparable part made of metal.

### EXAMPLES

The following examples and comparative examples further illustrate the present invention in detail but are not to be construed to limit the scope thereof.

In the following Examples, various terms and designations are used such as for example:

“HDT” stands for heat deflection temperature.

“NPGDGE” stands for neopentyldiglycidylether and is commercially available from Polystar LLC.

“DSC” stands for Differential Scanning calorimeter.

D.E.R. 331 epoxy resin is an epoxy resin having an EEW of 188 and commercially available from The Dow Chemical Company.

D.E.H. 58 curing agent is an amine curing agent commercially available from The Dow Chemical Company.

Chemcure 190 is an amine curing agent and commercially available from Polystar LLC.

In the following Examples, standard analytical equipment and methods are used such as for example:

HDT is measured according to ASTM D648.

Tensile strength, tensile modulus and elongation are measured according to ASTM D638.

Tg Measurement

Glass transition temperatures (T_{g}) of the cured formulations are measured using a T. A. Instruments Q200 differential scanning calorimetry instrument (DSC). Small samples (˜10 mg) of the cured plaques are placed into aluminum DSC pans with lids and heated under a nitrogen purge from 30° C. to 150° C. at 10° C./minute, cooled, then reheated a second time. The second heat scans are analyzed using the half extrapolated tangents method for reporting the cured Tg of the system.

Viscosity Measurement

ARES Rheometer (Advanced Rheometric Expansion System, SN 50001481) from T.A. Instruments equipped with Orchestrator V7.0.8.23 software with a 40 mm cone is used for the viscosity measurements. The viscosity measurement is carried out at 25° C.

Gel Time Measurement

The gel time measurement is carried out with Shyodu Gel Timer. 100 g of the sample is placed in a cup. A low-torque, synchronous motor rotates a specially shaped stirrer in the sample. When gelation occurs, the motor stops and gel time is measured from the clock attached to the Shyodu Gel Timer.

Epoxy Resin Compositions

The epoxy resin compositions are shown in Table I. Comparative Example A contains a standard epoxy resin and a standard epoxy diluent (NPGDGE). The two examples of the present invention (Examples 1 and 2) contain DVBDO (divinylarene dioxide).

TABLE I
Epoxy Resin Composition

| | Weight % | | |
|---|---|---|---|
| Component | Comparative Example A | Example 1 | Example 2 |
| D.E.R. 331 | 75 | 75 | 75 |
| NPGDGE | 25 | 12.5 | 0 |
| DVBDO | 0 | 12.5 | 25 |

Viscosity of Epoxy Resin Composition

The viscosity of the epoxy resin compositions are shown in Table II. The key to polymer concrete composition is lower viscosity of the epoxy resin composition. The Comparative Example A contains a standard epoxy resin and a standard epoxy diluent (NPGDGE). The two examples of the patent invention contain DVBDO (divinylarene dioxide). DVBDO reduces the viscosity of the epoxy resin composition similar to an epoxy diluent. There was no significant increase in viscosity in DVBDO containing epoxy resin composition.

TABLE II
Viscosity of Epoxy Resin Composition

| Component | Comparitive Example A | Example 1 | Example 2 |
|---|---|---|---|
| Viscosity@ 25° C. | 735 | 793 | 821 |
| (mPa · s) | | | |

Hardener Composition

The hardener composition used for Comparative Example A and Examples 1 and 2 is a blend of D.E.H. 58 and Chemcure 190. The composition details are shown in Table III.

TABLE III
Hardener Composition

| | Weight % |
|---|---|
| Sample ID | Hardener Composition |
| D.E.H. 58 | 40 |
| Chemcure 190 | 60 |

The curable composition for Comparative Example A, Example 1 and Example 2 are shown in Table IV.

TABLE IV
Curable Composition

| | Weight % | | |
|---|---|---|---|
| Component | Comparative Example A | Example 1 | Example 2 |
| Epoxy Resin | 75 | 75 | 75 |
| Composition | | | |
| Hardener | 25 | 25 | 25 |
| Composition | | | |

Gel Time Measurement

The gel times of the curable compositions are shown in Table V. The key to polymer concrete composition is having good reactivity (lower gel time). Comparative Example A contains a standard epoxy resin and a standard epoxy diluent (NPGDGE). The two examples of the present invention contain DVBDO (divinylarene dioxide). The results clearly indicate that here was no significant increase in gel time of a DVBDO containing epoxy resin composition. The reactivity of the DVBDO curable composition is identical to the epoxy diluent containing curable composition.

TABLE V
Gel Time Measurement

| Test | units | Comparative Example A | Example 1 | Example 2 |
|---|---|---|---|---|
| Gel Time | minutes | 33.1 | 35.6 | 38.5 |

Curable Composition Results

The curable composition results are shown in Table VI. The tests carried out included Tg and HDT measurements, and mechanical properties. The tests were carried out on clearing castings made from the curable compositions.

TABLE VI
Curable Composition Results

| Test | units | Comparative Example A | Example 1 | Example 2 |
|---|---|---|---|---|
| Tg | ° C. | 71.2 | 93.3 | 112.6 |
| HDT | ° C. | 81.6 | 86.1 | 100 |
| Tensile | MPa | 69 | 74 | 82 |
| Strength | | | | |
| Tensile | GPa | 3406 | 3298 | 3529 |
| Modulus | | | | |
| Elongation | % | 7.4 ± 0.2 | 8.1 ± 1.7 | 6.8 ± 0.7 |

In the present invention, a significant improvement in HDT is obtained as compared to the control formulation (Comparative Example A). Comparative Example A uses a conventional epoxy diluent, neopentyl glycoldiglycidylether; and Examples 1 and 2 use a divinylarene dioxide of the present invention. The increase in HDT is from 82° C. in Comparative Example A to 100° C. in Example 3. Examples 1 and 2 also show a significant improvement in glass transition temperature (Tg) of 93° C. and 112° C. respectively, as compared to Comparative Example A of 80° C. There were no significant differences in mechanical properties (tensile strength, tensile modulus, and elongation) for the above examples. Therefore, improvement in HDT was achieved without sacrificing viscosity of the resin component, reactivity (gel time) of the curable composition, and the final mechanical properties of the curable composition.

1. A curable composition for polymer concrete comprising
(A) at least one epoxy resin composition comprising a blend of
(A1) at least one epoxy resin, and
(A2) at least one divinylarene dioxide;
(B) at least one hardener composition; and
(C) at least one aggregates;
wherein the curable composition is adapted for providing a cured polymer concrete product made from the curable composition.

2. The curable composition of claim 1, wherein the composition being cured provides a cured product having a heat distortion temperature of greater than about 50° C.

3. The curable composition of claim 1, wherein the at least one aggregates comprises silica, sand, quartz, granite and mixtures thereof.

4. The curable composition of claim 1, wherein the concentration of the aggregates is in the range of from about 85 weight percent to about 95 weight percent.

5. The curable composition of claim 1, wherein the at least one epoxy resin (A1) comprises an aromatic epoxide.

6. The curable composition of claim 5, wherein the aromatic epoxide comprises a diglycidyl ether of bisphenol A, a diglycidyl ether of bisphenol F, or mixtures thereof.

7. The curable composition of claim 1, wherein the concentration of the at least one epoxy resin (A1) is in the range of from about 65 weight percent to about 85 weight percent.

8. The curable composition of claim 1, wherein the at least one divinylarene dioxide (A2) comprises divinylbenzene dioxide.

9. The curable composition of claim 1, wherein the concentration of the at least one divinylarene dioxide is in the range of from about 15 weight percent to about 35 weight percent.

10. The curable composition of claim 1, wherein the at least one hardener composition comprises anhydrides, carboxylic acids, amine compounds, phenolic compounds or mixtures thereof.

11. The curable composition of claim 1, wherein the concentration of the at least one hardener composition is in the range of from about 20 weight percent to about 40 weight percent.

12. The curable composition of claim 1, wherein the epoxy resin composition (A) includes an epoxy reactive diluent (A3).

13. A process for preparing a curable composition comprising admixing:
(A) at least one epoxy resin composition comprising
(A1) at least one epoxy resin, and
(A2) at least one divinylarene dioxide; and
(B) at least one hardener composition; and
(C) at least one aggregates;
wherein the curable composition is adapted for providing a cured polymer concrete product made from the curable composition.

14. A cured product comprising the cured composition of claim 1.

15. The cured product of claim 14 having a heat distortion temperature of greater than about 50° C.

16. A process for preparing the cured product of claim 14 comprising the steps of:
(I) admixing:
(A) at least one epoxy resin composition comprising
(A1) at least one epoxy resin, and
(A2) at least one divinylarene dioxide; and
(B) at least one hardener composition; and
(C) at least one aggregates;
wherein the curable composition is adapted for providing a cured polymer concrete product made from the curable composition; and
(II) thermally curing the composition prepared in step (I) at a temperature of from about 0° C. to about 300° C.

17. An article made from the cured product of claim 14.

18. The article of claim 17, wherein the product is polymer concrete.
